(19) United States
(12) Patent Application Publication
(10) Pub. No.: US 2026/0336316 A1
(43) Pub. Date: Oct. 29, 2026

(54) PRINTING APPARATUS

(71) Applicant: CANON KABUSHIKI KAISHA, Tokyo (JP)

(72) Inventors: YOHEI KUSANO, Tokyo (JP); RYO KOBAYASHI, Kanagawa (JP); KOSUKE TAGA, Kanagawa (JP)

(21) Appl. No.: 19/659,671

(22) Filed: Apr. 27, 2026

(30) Foreign Application Priority Data
Apr. 25, 2025 (JP) 2025-073569

(51) Int. Cl. B41J 29/377; B41J 11/00; B41J 29/02; F16L 37/00

(52) U.S. Cl. CPC B41J 29/377; B41J 11/0022; B41J 29/02; F16L 37/004

(57) ABSTRACT

A printing apparatus includes a conveyance unit, a printing unit and first and second ducts configured to form an exhaust passage for a gas. The first duct includes a first end portion unit. The second duct includes a second end portion unit connected to the first end portion unit. One of the first and second end portion units has a magnetic force generating portion. One of the first and second end portion units includes a hole portion. The other of the first and second end portion units includes an insertion portion inserted into the hole portion at connecting. The magnetic force generating portion is formed from a permanent magnet. The connecting direction is an inserting direction of the insertion portion with respect to the hole portion.

### BACKGROUND

### Field of the Technology

The present disclosure relates to a printing apparatus.

### Description of the Related Art

Buildings such as residences, commercial buildings, and factories are provided with air conditioning facilities for air-conditioning and ventilation. A large printing apparatus is configured to discharge heat and volatile organic compounds (VOCs) contained in ink and the like inside the apparatus by using ducts. For example, ducts are routed from the inside of the apparatus to the space above the ceiling of a factory. Known examples of connection structures for ducts are a structure using adhesive tapes and bands and a structure using bolts, pins, nails, staples, and the like. However, such structures require cumbersome connecting work and skills. Japanese Patent Laid-Open Nos. 2010-127447 and 5-65986 disclose connection structures using a magnetic force.

The structure disclosed in Japanese Patent Laid-Open No. 2010-127447 uses electromagnets and hence is disadvantageous in terms of always needing power supply. The structure disclosed in Japanese Patent Laid-Open No. 5-65986 has room for improvement in terms of the accuracy of positioning between ducts.

### SUMMARY

The present disclosure provides a technique that enables easy connecting work between ducts with relatively high accuracy.

According to an aspect of the present disclosure, there is provided a printing apparatus comprising: a conveyance unit configured to convey a print medium; a printing unit configured to print an image on the print medium; and first and second ducts configured to form an exhaust passage for a gas in the printing apparatus, wherein the first duct including a first end portion unit at an end portion of the first duct, the second duct includes a second end portion unit connected to the first end portion unit at an end portion of the second duct, one of the first end portion unit and the second end portion unit has a magnetic force generating portion configured to attract the other of the first end portion unit and the second end portion unit in a connecting direction with a magnetic force, one of the first end portion unit and the second end portion unit includes a hole portion, the other of the first end portion unit and the second end portion unit includes an insertion portion inserted into the hole portion at the time of connecting, the magnetic force generating portion is formed from a permanent magnet, and the connecting direction is an inserting direction of the insertion portion with respect to the hole portion.

Features of the present disclosure will become apparent from the following description of embodiments with reference to the attached drawings. The following description of embodiments is described by way of example.

### BRIEF DESCRIPTION OF THE DRAWINGS

FIG. 1 is a schematic view of a printing apparatus according to an embodiment of the present disclosure;

FIG. 2 is a perspective view of the printing apparatus in FIG. 1 with part of a side wall being not shown;

FIG. 3 is a perspective view of the printing apparatus in FIG. 1 with part of a side wall being not shown;

FIG. 4 is a plan view of the printing apparatus in FIG. 1 with part of the upper wall being not shown;

FIG. 5 is a perspective view of housings constituting a sub-housing, with side walls of the housings being not shown;

FIG. 6 is a perspective view of housings constituting a sub-housing, with side walls of the housings being not shown;

FIG. 7 is a perspective view of housings constituting a sub-housing, with side walls of the housings being not shown;

FIG. 8 is a view for explaining an exhaust passage in the printing apparatus in FIG. 1;

FIG. 9 is a view for explaining a connection structure;

FIG. 10 is a view for explaining the connection structure;

FIG. 11 is a view for explaining the connection structure;

FIG. 12 is a view for explaining another connection structure; and

FIG. 13 is a view for explaining still another connection structure.

### DESCRIPTION OF THE EMBODIMENTS

Hereinafter, embodiments will be described in detail with reference to the attached drawings. Note, the following embodiments are not intended to limit the scope of the claims. Multiple features are described in the embodiments, but it is not the case that all such features are required, and multiple such features may be combined as appropriate. Furthermore, in the attached drawings, the same reference numerals are given to the same or similar configurations, and redundant description thereof is omitted.

### First Embodiment

### Outline of Apparatus

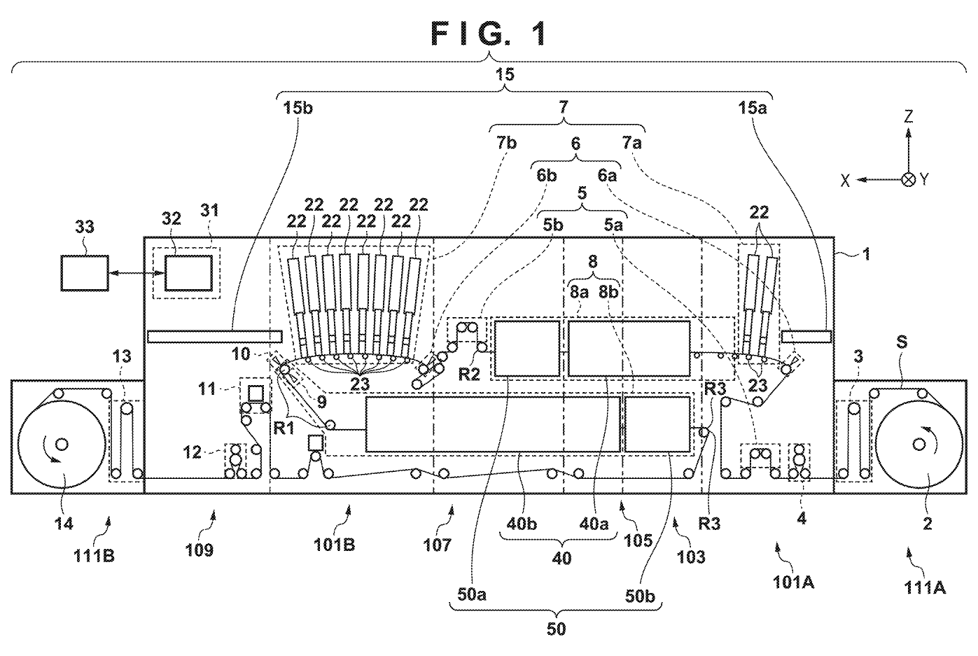

FIG. 1 is a schematic view of a printing apparatus 1 according to one embodiment of the present disclosure. The printing apparatus 1 is an industrial high-speed line printer using a sheet wound in a roll as a print medium. Although the printing apparatus 1 is an inkjet printing apparatus, the present embodiment can also be applied to other types of printing apparatuses such as an electrophotographic printing apparatus.

Note that "print" includes not only forming significant information such as characters and graphics but also forming images, figures, patterns, and the like on print media in a broad sense, or processing media, regardless of whether the information is significant or insignificant or whether the information is visualized so that a human can visually perceive it. In addition, although in this embodiment, sheet-like paper is assumed as a "print medium", cloth, a plastic film, and the like may also be used.

In the drawings, arrows X, Y, and Z indicate directions crossing each other. In the present embodiment, the X direction and the Y direction are horizontal directions orthogonal to each other, and the Z direction is the up/down direction. The X direction is the longitudinal direction of the printing apparatus 1. Print media are sequentially conveyed substantially in the X direction. The downstream side and the upstream side are defined based on the conveyance direction of a print medium as a reference. The Y direction is the width direction of a print medium.

The printing apparatus 1 includes an unwinding roll unit 2, a dancer unit 3, a conveyance unit 4, a meander correction unit 5, a detection unit 6, a printing unit 7, a detection unit 9, and a detection unit 10. The printing apparatus 1 further includes a scanner unit 11, a conveyance unit 12, a dancer unit 13, a winding roll unit 14, a maintenance unit 15, a fixing unit 40, and a cooling unit 50. A sheet S as a print medium is sequentially conveyed to the respective units along a conveyance path so as to be processed by each unit.

In the printing apparatus 1, two printing steps are executed with respect to the sheet S. In the first printing step, an image is printed on the sheet S through a printing unit 7a, a fixing unit 40a, and a cooling unit 50a. In the second printing step, an image is printed on the sheet S through a printing unit 7b, a fixing unit 40b, and a cooling unit 50b.

As described above, in the printing apparatus 1, images can be consecutively formed on the sheet S in two printing steps. The printing apparatus 1 selects one of the two printing steps in accordance with printing conditions. In this case, an image is printed on the sheet S in only the selected printing step.

The unwinding roll unit 2 is a unit for holding and supplying a sheet wound in a roll. The unwinding roll unit 2 accommodates an unwinding roll and takes out and supplies the sheet S. The number of rolls that can be accommodated is not limited to one. Two or three or more rolls may be accommodated. One of the rolls may be selected, and the sheet S may be taken out and supplied.

The dancer unit 3 is a unit for applying a predetermined tensile force between the unwinding roll unit 2 and the conveyance unit 4 and includes a tensile force applying mechanism that applies the tensile force to the sheet S.

The conveyance unit 4 is a unit for conveying the sheet S to each unit and applying a tensile force to the sheet between itself and the scanner unit 11. The conveyance unit 4 includes a roller that is rotated by driving a motor (not shown) and tension-conveys the sheet S.

The meander correction unit 5 is a unit for correcting the meander of the sheet S in the sheet width direction at the time of conveying the sheet S. The meander correction unit 5 according to the present embodiment includes a meander correction unit 5a and a meander correction unit 5b corresponding to the respective printing steps.

Each of the meander correction units 5a and 5b includes a meander correction roller and a sensor that detects the meander of the sheet S. The meander correction roller is driven by a motor (not shown), can change the inclination of the sheet S, and corrects the meander of the sheet S based on the detection result obtained by the sensor.

The detection unit 6 is a unit for detecting the conveying speed of the sheet S and the mark formed in advance on the sheet S to control the printing timing of the printing unit 7. The detection unit 6 according to the present embodiment includes a detection unit 6a and a detection unit 6b each corresponding to a corresponding one of the printing steps. The detection unit 6a and the detection unit 6b are respectively used to control the printing timings of the printing unit 7a and the printing unit 7b.

The printing unit 7 includes the printing unit 7a and the printing unit 7b each corresponding to a corresponding one of the printing steps. The printing unit 7a and the printing unit 7b each include a printhead 22 that discharges a liquid and print an image by discharging a liquid from above to the conveyed sheet S. The conveyance path for the sheet S at the printing unit 7a and the printing unit 7b is formed by guide rollers 23 arranged in an arcuated shape convex upward. The guide rollers 23 apply a predetermined tensile force to the sheet S to secure a clearance between the printhead 22 and the sheet S.

The printing unit 7a and the printing unit 7b each include a plurality of printheads 22 arranged in the conveying direction of the sheet S. Each printhead 22 is a full-line head. In the present embodiment, the printing unit 7a includes a total of two printheads 22 respectively corresponding to white (W) ink and a reaction liquid. The printing unit 7b includes a total of eight printheads 22 respectively corresponding to a reaction liquid and three spot colors in addition to four colors, namely, black (Bk), yellow (Y), magenta (M), and cyan (C).

A reaction liquid is a liquid containing a component that increases the viscosity of ink. In this case, an increase in the viscosity of ink is a state in which as a color material, a resin, and the like constituting the ink come into contact with a component that increases the viscosity of the ink, a chemical reaction or physical adsorption increases the ink viscosity. An increase in the viscosity of ink is not limited to an increase in the entire viscosity of the ink and includes a case where the aggregation of components constituting ink, such as a color material and a resin, causes a local increase in viscosity. A component that increases the viscosity of ink is not limited to any specific material such as metal ions or a polymer coagulant. A material that changes the pH of the ink to make the color material in the ink aggregate and an organic acid can be used.

Applying a reaction liquid onto the sheet S before the application of ink can improve the fixability of the ink having reached the sheet S. This makes it possible to prevent bleeding of adjacent inks.

Note that the numbers of color types and colors and the number of printheads 22 are not specifically limited. The inkjet scheme to be used may be any scheme, such as a scheme using heating elements, a scheme using piezoelectric elements, a scheme using electrostatic elements, or a scheme using MEMS elements. Ink is supplied from each tank to the printhead 22 through a corresponding tube.

The detection unit 9 is a unit for detecting the tensile force of the sheet S at the time of conveying the sheet S between the conveyance unit 4 and the conveyance unit 12. The detection unit 10 is a unit for correcting a printing position by detecting the displacement of the image printed on the sheet S by the printing unit 7 during printing.

A winding guide roller R1 is a roller around which the sheet S located downstream of the printing unit 7b is wound at a predetermined winding angle. In the present embodiment, two winding guide rollers R1 are arranged between the printing unit 7b and the fixing unit 40b below the printing unit 7b. The sheet S is folded back by these rollers.

The fixing unit 40 includes the fixing unit 40a and the fixing unit 40b each corresponding to a corresponding one of the printing steps. The fixing units 40a and 40b each are a unit that increases the fixability of ink to the sheet S by reducing the liquid component contained in the liquid discharged onto the sheet S at a corresponding one of the units 7a and 7b. The fixing units 40a and 40b of the present embodiment each are a drying unit that dries applied ink by blowing air to the sheet S. The fixing units 40a and 40b each dry the ink-applied surface of the sheet S by blowing air from at least ink-applied surface side to the sheet S passing through the unit. Note that the drying scheme to be used may be a combination of the scheme of blowing air and a scheme of irradiating the surface of the sheet S with electromagnetic waves (ultraviolet light, infrared light, or the like) or a conductive heat transfer scheme based on contact of heating elements.

The cooling unit 50 includes the cooling unit 50a and the cooling unit 50b each corresponding to a corresponding one of the printing steps. The cooling units 50a and 50b each solidify softened ink by cooling the sheet S on which an image is fixed by a corresponding one of the fixing units 40a and 40b and also suppress the change amount of temperature of the sheet S. The cooling units 50a and 50b each cool the ink-applied surface of the sheet S by blowing air having a temperature lower than that of the sheet S from at least the ink-applied surface side to the sheet S passing through the unit. Note that the cooling scheme to be used is not limited to the scheme of blowing air and may be a conductive heat transfer scheme based on contact of a heat dissipation unit material or a combination thereof.

The scanner unit 11 is a unit for correcting printing conditions by reading the test images formed on the sheet S by the printing unit 7 before actual printing and detecting the displacements and densities of the images.

The conveyance unit 12 conveys the sheet S together with the conveyance unit 4 while applying a tensile force to the sheet S. The conveyance unit 12 includes a roller that is rotated by being driven by a motor (not shown). The speed of the conveyance unit 12 is controlled in accordance with the tensile force value on the sheet S which is detected by the detection unit 9.

Note that as an additional configuration for adjusting a tensile force on the sheet S, the tensile force on the sheet S may be adjusted by driving the roller through a clutch. In this case, there may be prepared, as tensile force control methods, two methods, namely, a torque control method of controlling the torque value transferred from the clutch and a speed control method of controlling the roller speed of the conveyance unit 12, and the tensile force control methods can be switched or concurrently used in accordance with the purpose.

The dancer unit 13 is a unit for applying a predetermined tensile force to the sheet S between the conveyance unit 12 and the winding roll unit 14. The winding roll unit 14 is a unit for winding the sheet S having undergone printing around the core. The number of rolls that can be recovered is not limited to one, and the winding roll unit 14 may have two or three or more cores and may be configured to recover the sheet S upon selectively switching the cores. Depending on the contents of processing after printing, this apparatus may be configured to cut a sheet by using a cutter and stack the cut sheet S instead of winding the sheet around the core.

A control unit 31 is a unit that controls each unit of the printing apparatus 1 as a whole. The control unit 31 includes a controller including a CPU, a storage device, and various types of control units, an interface, and an operation unit 32 with which the user performs an input/output operation. The operation of the printing apparatus 1 is controlled based on commands from the controller or a host apparatus 33 such as a host computer connected to the controller via an interface.

The maintenance unit 15 is a unit including a mechanism for recovering the discharging performance of the printhead 22. The maintenance unit 15 includes a maintenance unit 15a corresponding to the printing unit 7a and a maintenance unit 15b corresponding to the printing unit 7b. The maintenance units 15a and 15b each include, for example, a cap mechanism for protecting the ink discharge surface of the printhead 22, a wiper mechanism for wiping the ink discharge surface, and a suction mechanism for removing ink in the printhead 22 from the ink discharge surface by negative pressure suction. The maintenance units 15a and 15b each can be reciprocally moved in the horizontal direction by a driving mechanism (not shown) and rails. The maintenance units 15a and 15b each move to immediately below the printhead 22 at the time of maintenance of the printhead 22 and move from immediately below the printhead 22 to a retreat position.

### Housing Structure

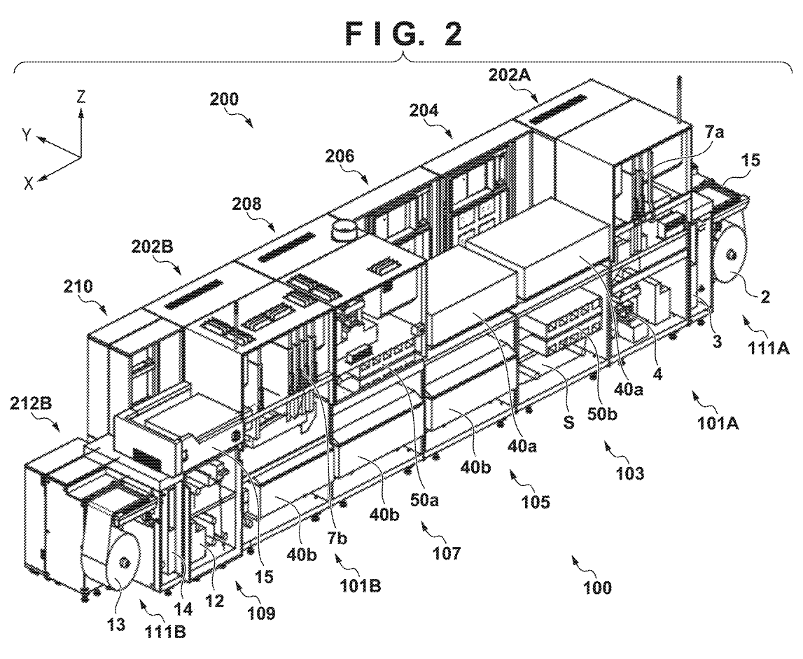

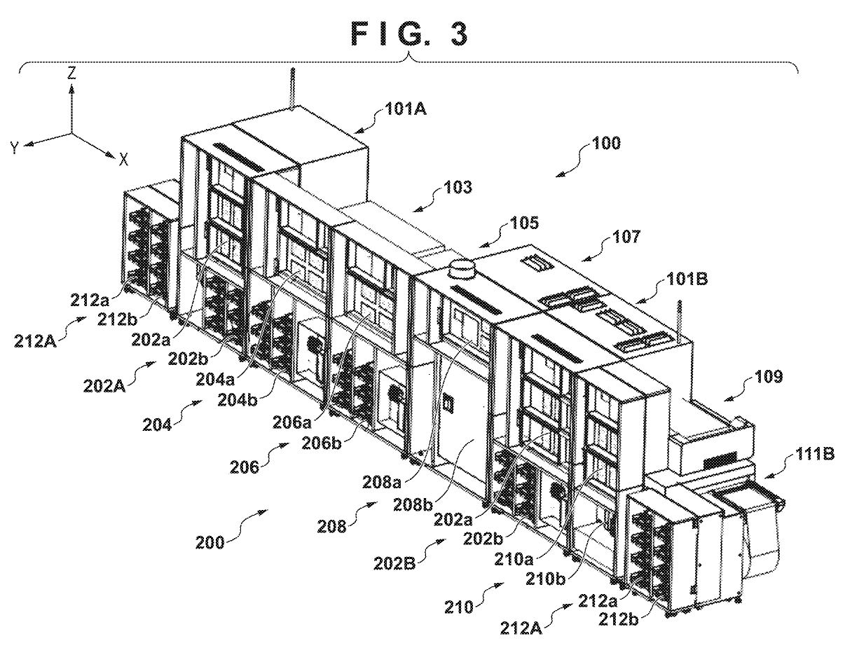

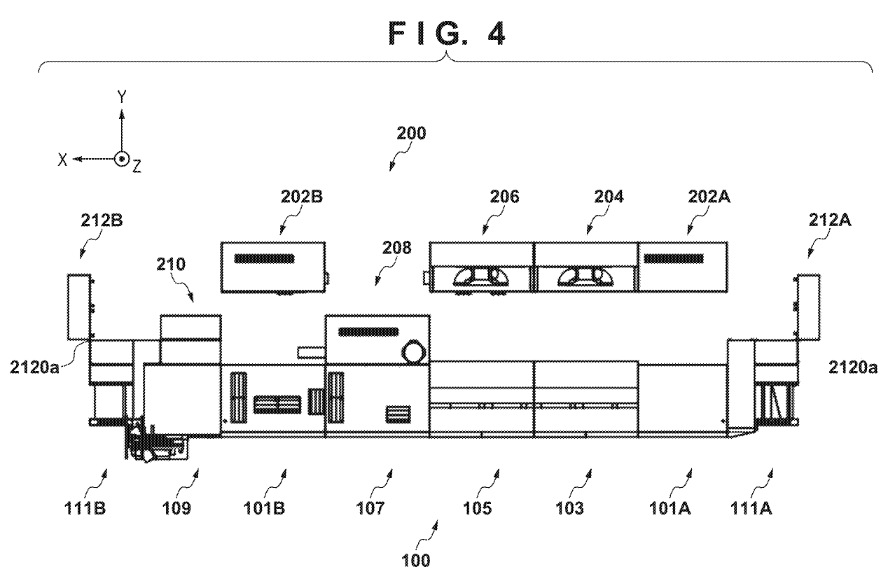

The structure of a housing forming the outer wall of the printing apparatus 1 will be described with reference to FIGS. 2-4 in addition to FIG. 1. Each of FIGS. 2 and 3 is a perspective view of the printing apparatus 1 with part of a side wall being not shown. FIG. 4 is a plan view of the printing apparatus 1 with part of the upper wall being not shown, showing a state in which some components are separated.

The printing apparatus 1 includes a main housing 100 accommodating each unit described above and a sub-housing 200 mainly accommodating electrical components such as a control circuit and the like for each unit. The main housing 100 includes a plurality of housings 111A, 101A, 103, 105, 107, 101B, 109, and 111B arrayed in the X direction. The sub-housing 200 includes a plurality of housings 212A, 202A, 204, 206, 208, 202B, 210, and 212B arrayed in the X direction. The main housing 100 and the sub-housing 200 are arranged adjacent to each other in the Y direction.

The housing 101A accommodates the conveyance unit 4, the maintenance unit 15, and the printing unit 7a. The housing 202A accommodates a control board 202a for the conveyance unit 4, the maintenance unit 15, and the printing unit 7a, and a power supply 202b that activates the conveyance unit 4, the maintenance unit 15, and the printing unit 7a. The housing 202A is coupled to the housing 101A so as to be separable therefrom in the Y direction.

The housing 103 accommodates part of each of the fixing units 40a and 40b. The housing 204 accommodates a control board 204a for the fixing units 40a and 40b and a power supply 204b that activates the fixing units 40a and 40b. The housing 204 is coupled to the housing 103 so as to be separable therefrom in the Y direction.

The housing 105 accommodates part of the fixing unit 40a and the cooling unit 50b. The housing 206 accommodates a control board 206a for the fixing unit 40a and the cooling unit 50b and a power supply 206b that activates the fixing unit 40a and the cooling unit 50b. The housing 206 is coupled to the housing 105 so as to be separable therefrom in the Y direction.

The housing 107 accommodates part of the fixing unit 40b and the cooling unit 50a. The housing 208 accommodates a control board 208a for the fixing unit 40b and the cooling unit 50a and a power supply 208b that activates the fixing unit 40b and the cooling unit 50a. The housing 208 is coupled to the housing 107 so as to be separable therefrom in the Y direction.

The housing 101B accommodates part of the fixing unit 40b and the printing unit 7b. The housing 202B accommodates the control board 202a for the fixing unit 40b and the printing unit 7b and the power supply 202b that activates the fixing unit 40b and the printing unit 7b. The housing 202B is coupled to the housing 101B so as to be separable therefrom in the Y direction.

The housing 109 accommodates the conveyance unit 12 and the maintenance unit 15. The housing 210 accommodates a control board 210a for the conveyance unit 12 and the maintenance unit 15 and a power supply 210b that activates the conveyance unit 12 and the maintenance unit 15. The housing 210 is coupled to the housing 109 so as to be separable therefrom in the Y direction.

The housing 111A accommodates the unwinding roll unit 2 and the dancer unit 3. The housing 212A accommodates a control board 212a for the unwinding roll unit 2 and the dancer unit 3 and a power supply 212b that activates the unwinding roll unit 2 and the dancer unit 3. The housing 212A is coupled to the housing 111A so as to be pivotal about a hinge 2120a.

The housing 111B accommodates the dancer unit 13 and the winding roll unit 14. The housing 212B accommodates the control board 212a for the dancer unit 13 and the winding roll unit 14 and the power supply 212b that activates the dancer unit 13 and the winding roll unit 14. The housing 212B is coupled to the housing 111B so as to be pivotal about the hinge 2120a.

Note that the housing 212A and the housing 212B may be configured to be coupled to the housing 111A and the housing 111B so as to be separable therefrom in the Y direction. The main housing 100 is coupled to the sub-housing 200 by using coupling members such as screws, snap fits, cam lock fasteners, and coupling pins.

### Sub-Housing

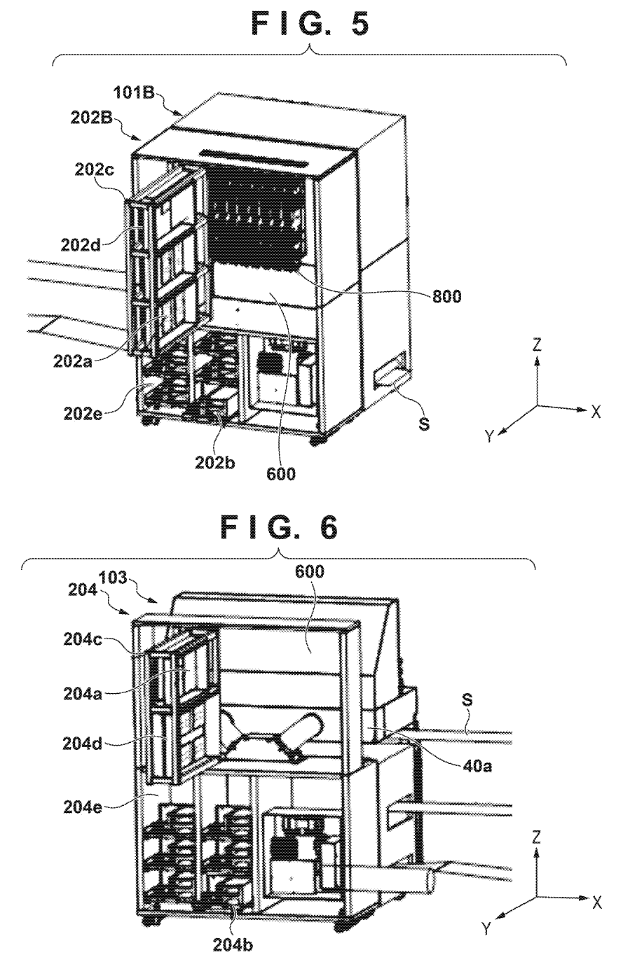

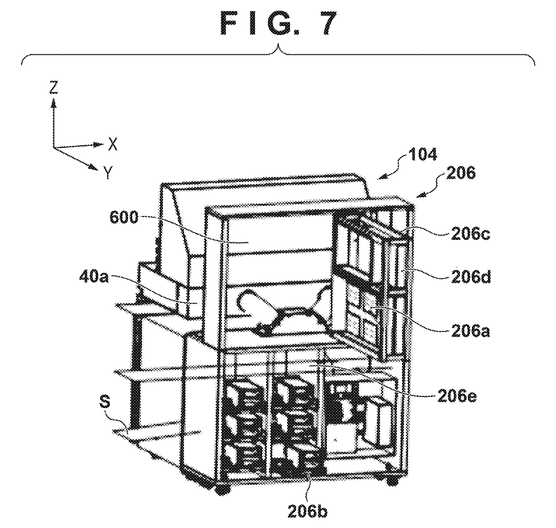

FIG. 5 is a perspective view of the housing 202B with its side wall being not shown. FIG. 6 is a perspective view of the housing 204 with its side wall being not shown. FIG. 7 is a perspective view of the housing 206 with its side wall being not shown.

As shown in FIG. 5, the housing 202B includes a substrate storage unit 202d in a door 202c on the upper side inside the housing 202B. The control board 202a for the fixing unit 40b and the printing unit 7b is arranged in the substrate storage unit 202d. The housing 202B further includes an ink circulation unit 800 on the housing 101B side with respect to the door 202c. The inside of the region of the ink circulation unit 800 communicates with the housing 101B through a communication port 600. Opening the door 202c allows access to the ink circulation unit 800, thereby allowing maintenance without detaching unit products or moving the housing.

A power supply storage unit 202e on the lower side inside the housing 202B is provided with the power supply 202b that activates the fixing unit 40b and the printing unit 7b. The power supply 202b is supported in the housing 202B so as to be drawable therefrom in the Y direction.

As shown in FIG. 6, the housing 204 includes a substrate storage unit 204d in a door 204c on the upper side inside the housing 204. In the substrate storage unit 204d, the control board 204a for the fixing unit 40a and the fixing unit 40b is arranged. The housing 204 further includes the fixing unit 40a on the housing 103 side with respect to the door 204c. The inside of the region of the fixing unit 40a communicates with the third housing 103 through the communication port 600. Opening the door 204c allows access to the fixing unit 40a, thereby allowing maintenance without detaching unit products or moving the housing.

A power supply storage unit 204e on the lower side inside the housing 204 is provided with the power supply 204b that activates the fixing unit 40a and the fixing unit 40b. The power supply 204b is supported in the housing 204 so as to be drawable therefrom in the Y direction.

As shown in FIG. 7, the housing 206 includes a substrate storage unit 206d in a door 206c on the upper side in the housing 206. The control board 206a for the fixing unit 40a and the cooling unit 50b is arranged in the substrate storage unit 206d. The housing 206 further includes the fixing unit 40a on the housing 105 side with respect to the door 206c. The inside of the region of the fixing unit 40a communicates with the fifth housing 105 through the communication port 600. Opening the door 206c allows access to the fixing unit 40a, thereby allowing maintenance without detaching unit products or moving the housing.

A power supply storage unit 206e on the lower side inside the housing 206 is provided with the power supply 206b that activates the fixing unit 40a and the cooling unit 50b. The power supply 206b is supported in the housing 206 so as to be drawable therefrom in the Y direction.

### Exhaust Passage

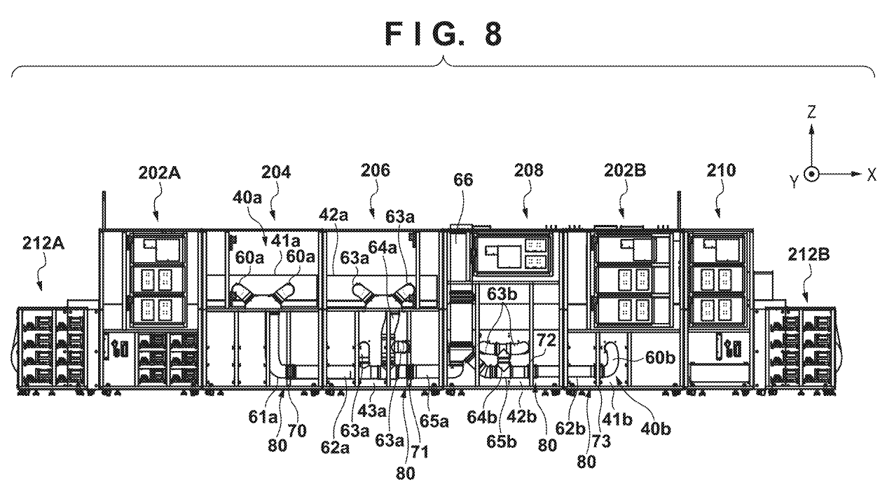

The configuration of the exhaust passage will be described next with reference to FIG. 8. FIG. 8 is a view for explaining the exhaust passage of the printing apparatus 1 viewed from the sub-housing 200 side. The fixing units 40a and 40b according to the present embodiment facilitate drying ink by blowing air. Exhaust ducts are provided to exhaust the air used for drying to the outside of the printing apparatus 1. The ducts are routed in the sub-housing 200.

The housing 202B faces a unit 41b constituting the fixing unit 40b, and a duct 60b is connected to the unit 41b. The duct 60b is separably connected to a duct 62b through a connection structure 80. Drawing the power supply storage unit 202e arranged in the housing 202B in the Y direction can connect and separate the duct 60b to and from the duct 62b. The duct 62b is supported by a support member 73 partitioning the inside of the housing 202B and extends in the X direction.

The housing 208 faces a unit 42b constituting the fixing unit 40b, and a pair of ducts 63b are connected to the unit 42b. The pair of ducts 63b are connected to a duct 64b as a collecting duct. The duct 64b is connected to a duct 65b. The duct 65b is separably connected to the duct 62b through the connection structure 80. The duct 65b is supported by a support member 72, extends in the X direction so as to bend midway obliquely upward, and is connected to a duct 66 as a collecting duct.

The housing 206 faces a unit 42a constituting the fixing unit 40a, and a pair of ducts 63a are connected to the unit 42a. The pair of ducts 63a are connected to a duct 64a as a collecting duct. The duct 64a extending up and down is connected to a duct 62a extending in the X direction. The duct 62a is separably connected to a duct 65athrough the connection structure 80. The duct 62a is supported by a support member 71. Opening the door 206c of the housing 206 allows access to the fixing unit 40a, thereby enabling connection and separation of a duct 63a. Drawing the power supply storage unit 206e arranged in the housing 206 in the Y direction enables connection and separation of the duct 65a. The duct 65a is connected to the duct 66.

The housing 206 faces a unit 43a constituting the fixing unit 40a, and the two ducts 63a are connected to the unit 43a. The ducts 63a are connected to the duct 62a or 64a.

The housing 204 faces a unit 41a constituting the fixing unit 40a, and a pair of ducts 60a are connected to the unit 41a. The pair of ducts 60a are connected to a duct 61a as a collecting duct. The duct 61a extending up and down is connected to the duct 62a extending in the X direction. The duct 61a is separably connected to the duct 62a through the connection structure 80. The duct 61a is supported by a support member 70. Opening the door 204c of the housing 204 allows access to the fixing unit 40a, thereby enabling connection and separation of the ducts 60a. Drawing the power supply storage unit 204e arranged in the housing 204 in the Y direction enables connection and separation of the duct 62a.

The duct 66 extending up and down is connected to the chimney (not shown) of the factory where the printing apparatus 1 is installed. Exhaust gases from the fixing units 40a and 40b are discharged from the chimney through the duct 66.

### Connection Structure

A configuration example of the connection structure 80 will be described. Although the connection structure 80 that connects the duct 65a to the duct 62a will be described hereinafter, the connection structure 80 for other connecting portions has a similar structure. Note that the connection between ducts in portions which do not use the connection structure 80 is performed by using connection members such as adhesive tapes, bands, and pins without using any magnetic force used for the connection between general ducts. The connection between ducts in portions which do not use the connection structure 80 includes, for example, the connection between the ducts 60a and the duct 61a, the connection between the duct 62a and the duct 63a, and the connection between the duct 64b and the duct 65b. Using connection members using no magnetic force for portions with low frequencies of connection and separation can prevent unnecessary separation between ducts.

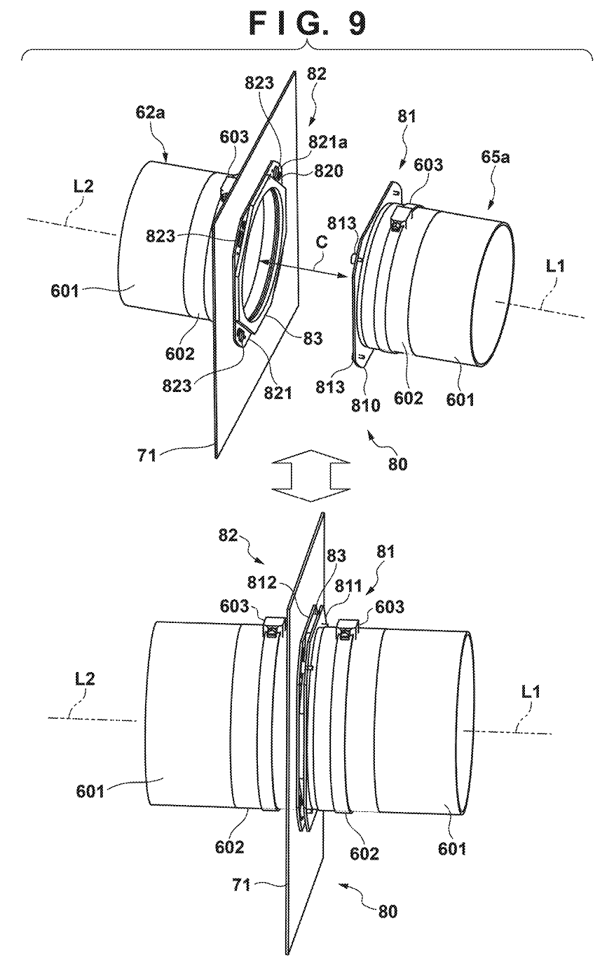

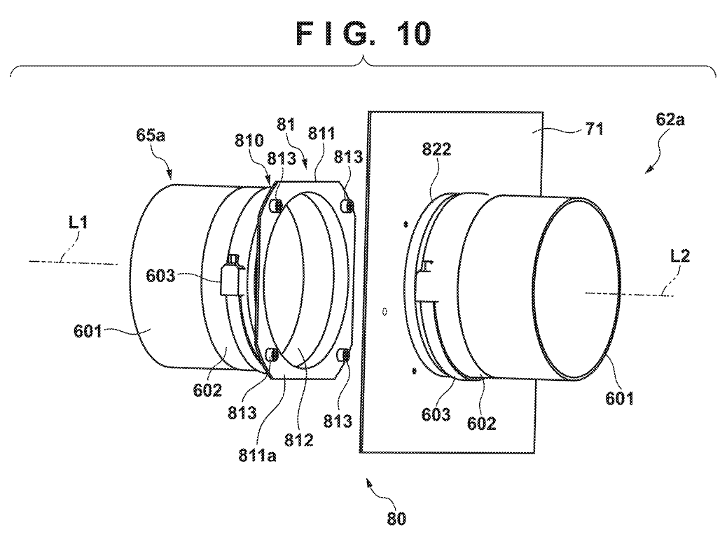

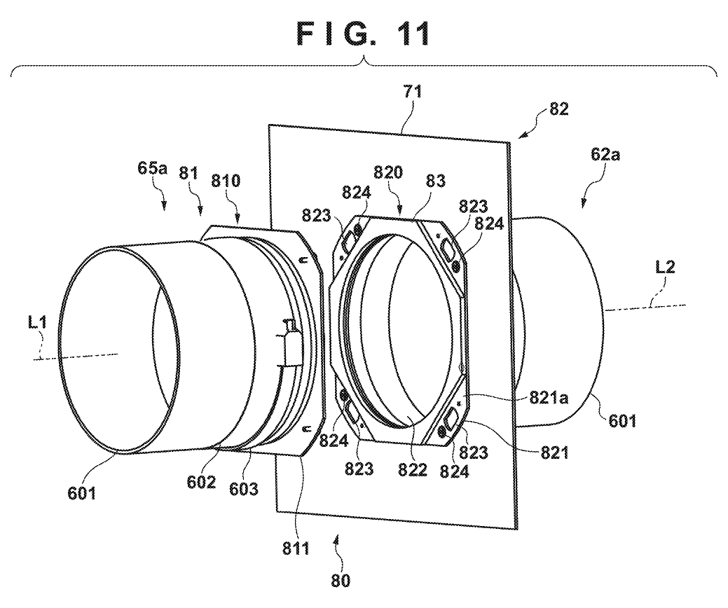

FIG. 9 is a view for explaining the connection structure 80 and also a perspective view showing the separated state and the connected state between end portions of the duct 65a and the duct 62a. Referring to FIG. 9, an arrow C indicates the connecting direction of the end portions of the duct 65a and the duct 62a, which is the X direction in the present embodiment. FIGS. 10 and 11 are perspective views showing the separated states of the end portions of the duct 65a and the duct 62a from different points of view.

The end portion of the duct 65a is provided with an end portion unit 81. The end portion of the duct 62a is provided with an end portion unit 82.

The end portion unit 81 includes an end portion member 810. The end portion member 810 includes a flange portion 811 and a cylindrical portion 812. The flange portion 811 is located at an end portion of the cylindrical portion 812. The cylindrical portion 812 is airtightly fixed to a hose 601 constituting the main portion of the duct 65a with a tape 602 such as aluminum tape and a hose band 603. A line L1 is the central axis line of the cylindrical portion 812. The extending direction of the central axis line L1 coincides with a connecting direction C.

The flange portion 811 has a flange surface 811a facing the end portion unit 82. The flange portion 811 includes a plurality of insertion portions 813 each having a columnar shape protruding from the flange surface 811a. The insertion portion 813 protrudes parallel to the central axis line L1. The insertion portion 813 is formed from a permanent magnet and functions as a magnetic force generating portion. The plurality of insertion portions 813 are arranged at an equal pitch in the circumferential direction of the cylindrical portion 812 (the circumferential direction of the central axis line L1). In the present embodiment, four insertion portions 813 are formed.

The end portion unit 82 includes an end portion member 820. The end portion member 820 includes a flange portion 821 and a cylindrical portion 822. The flange portion 821 is located at an end portion of the cylindrical portion 822. The cylindrical portion 822 is airtightly fixed to the hose 601 constituting the main portion of the duct 62a with the tape 602 such as aluminum tape and the hose band 603. A line L2 is the central axis line of a cylindrical portion 822. The extending direction of the central axis line L2 coincides with the connecting direction C. The cylindrical portion 812 and the cylindrical portion 822 communicate with each other at the time of connecting, thus forming a flow passage for a fluid (exhaust passage).

The flange portion 821 includes a flange surface 821a facing the end portion unit 81. The flange portion 821 has a plurality of hole portions 823. Each insertion portion 813 is inserted into a corresponding one of the hole portions 823 at the time of connecting. In the present embodiment, each hole portion 823 is a through hole extending through the flange portion 821. The plurality of hole portions 823 are arranged at an equal pitch in the circumferential direction of the cylindrical portion 822 (the circumferential direction of the central axis line L2). In the present embodiment, four hole portions 823 are formed. Each hole portion 823 has an arcuated shape extending in the circumferential direction of the cylindrical portion 822 (the circumferential direction of the central axis line L2).

In the present embodiment, the support member 71 serves as both a plate-like partitioning member that partitions the housing 206 and a constituent component of the end portion unit 82. The support member 71 is fixed to the back surface of the flange portion 821 (the opposite surface to the flange surface 821a) with a plurality of fixing members 824 such as screws and forms the bottom portion of the hole portion 823 so as to close the hole portion 823. The support member 71 is a magnetic member such as a galvanized steel sheet. A magnetic attractive force is generated between the insertion portion 813 as a permanent magnet and the support member 71.

A seal member 83 is arranged between the flange surface 811a and the flange surface 821a. The seal member 83 has an opening having a diameter similar to the inner diameter of the cylindrical portions 812 and 822 and prevents an exhaust gas from leaking from between the flange surface 811a and the flange surface 821a. In order to improve the convenience for connecting work, the seal member 83 may be bonded to the flange surface 821a in advance.

Connecting work between the duct 62a and the duct 65a will be described. The duct 62a is fixed to the housing 206 through the support member 71. This improves the workability because the worker can perform connecting work while supporting only the duct 65a.

Referring to the upper diagram in FIG. 9, in a state in which the seal member 83 is arranged between the flange surface 811a and the flange surface 821a, the end portion unit 81 of the duct 65a is brought close to the end portion unit 82 of the duct 62a in a connecting direction C while each insertion portion 813 is aligned with a corresponding one of the hole portions 823.

As shown in the lower diagram in FIG. 9, the end portion unit 81 and the end portion unit 82 are connected to each other in the connecting direction C with the magnetic attractive force generated between the insertion portion 813 and the support member 71. The hole portion 823 is located closer to the end portion member 810 than the support member 71. The flange portion 821 is located between the flange portion 811 and the support member 71.

Since the insertion/removal direction between insertion portion 813 and the hole portion 823 coincides with the connecting direction C, the insertion portion 813 is inserted into the hole portion 823. Inserting the insertion portion 813 into the hole portion 823 will engage them with each other and position them with each other in a direction intersecting the connecting direction C (the radial direction of the central axis lines L1 and L2) between the end portion unit 81 and the end portion unit 82, thereby completing centering of the cylindrical portions 812 and 822. Using the insertion portion 813 as both a positioning member and a magnetic force generating member can reduce the number of components.

Since the hole portion 823 has an arcuated shape, the insertion portion 813 can be moved within the range of the length of the hole portion 823 in the circumferential direction. That is, the end portion unit 81 can be rotated relative to the end portion unit 82 by a small amount in the circumferential direction of the central axis lines L1 and L2. This makes it possible to perform position adjustment (phase adjustment) of the two units in the circumferential direction.

The seal member 83 is clamped between the flange surface 811a and the flange surface 821a and pressed by these flange surfaces. This improves the airtightness of the connection portion.

With the above process, the connecting work is completed. Engaging the insertion portion 813 with the hole portion 823 can perform positioning between the ducts 62a and 65a with relatively high accuracy and can facilitate the connecting work by using a magnetic force.

A magnetic attractive force and the repulsive force of the seal member 83 will be described. The repulsive force generated when the seal member 83 is pressed is, for example, about 10 N. The self-weight of the duct 65a is, for example, about 10 N, and the total magnetic force of the four insertion portions 813 is, for example, about 70 N. In this case, the holding force of the duct 65a with respect to the support member 71 is about 50 N. Accordingly, the manipulation force the user needs to apply when separating the duct 65a from the duct 62a is about 50 N. The attractive force generated by the magnetic force of the insertion portions 813 is small enough to allow the worker to manually separate the ducts. This makes it possible to easily connect and separate the duct 65a and the duct 62a in a short time.

The configurations of the end portion units 81 and 82 may be interchanged in accordance with the duct 65a and the duct 62a. In addition, two seal members 83 may be respectively bonded to the flange surface 811a and the flange surface 821a in advance. The end portion member 810 may be entirely or partly formed from a permanent magnet instead of the insertion portion 813. In addition, the end portion member 820 including the hole portion 823 may be entirely or partly formed from a magnetic material. This eliminates the necessity of the support member 71 as a member on which a magnetic attractive force acts.

### Second Embodiment

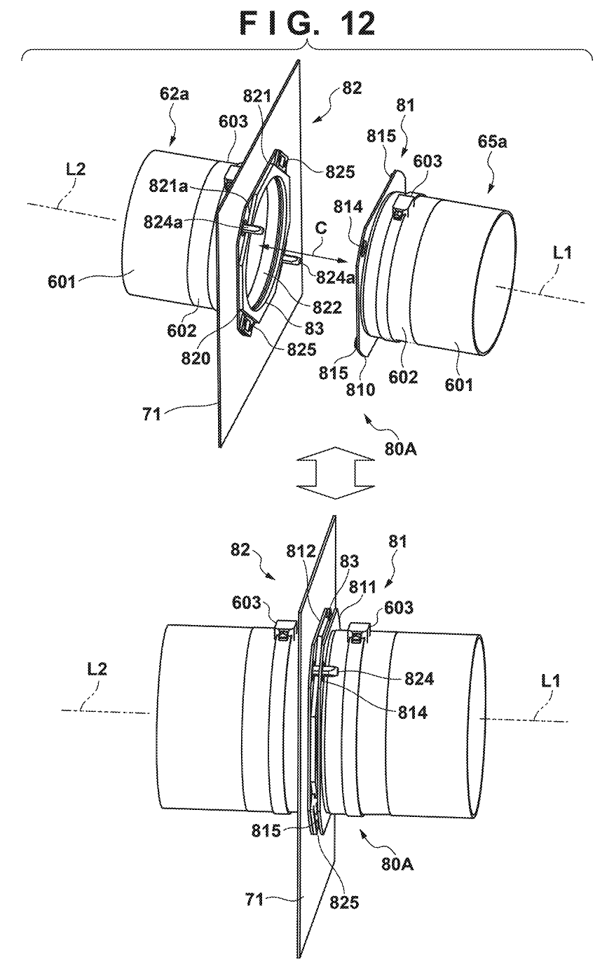

FIG. 12 shows another configuration example of the connection structure 80. Configurations different from those of the first embodiment will be described.

A flange portion 821 of an end portion member 820 is provided with a plurality of insertion portions 824a. In the present embodiment, each insertion portion 824a is a guide pin protruding from a flange surface 821a. The plurality of insertion portions 824a are arranged at an equal pitch in the circumferential direction of a cylindrical portion 822 (the circumferential direction of a central axis line L2). In the present embodiment, two insertion portions 824 are formed.

The flange surface 821a is also provided with a plurality of abutment portions 825. The abutment portion 825 is a magnet catch (permanent magnet) functioning as a magnetic force generating portion. The plurality of abutment portions 825 are arranged at an equal pitch in the circumferential direction of the cylindrical portion 822 (the circumferential direction of the central axis line L2). In the present embodiment, the two abutment portions 825 are formed. In addition, a total of four insertion portions 824 and abutment portions 825 are alternately arranged at an equal pitch in the circumferential direction of the cylindrical portion 822 (the circumferential direction of the central axis line L2).

A flange portion 811 of an end portion member 810 is provided with a plurality of hole portions 814. In the present embodiment, each hole portion 814 is a through hole extending through the flange portion 811. The plurality of hole portions 814 are arranged at an equal pitch in the circumferential direction of a cylindrical portion 812 (the circumferential direction of the central axis line L1). In the present embodiment, two hole portions 814 are formed. FIG. 12 shows one hole portion 814 of the two hole portions 814 while not showing the other hole portion 814.

A flange surface 811a is provided with a plurality of abutment portions 815. The abutment portion 815 is a magnetic member that is made of a galvanized steel sheet or the like and functions as a receiving portion for the magnet catch. The plurality of abutment portions 815 are arranged at an equal pitch in the circumferential direction of the cylindrical portion 812 (the circumferential direction of a central axis line L1). In the present embodiment, two abutment portions 815 are formed. In addition, a total of four hole portions 814 and abutment portions 815 are alternately arranged at an equal pitch in the circumferential direction of the cylindrical portion 812 (the circumferential direction of the central axis line L1).

Referring to the upper diagram in FIG. 12, in a state in which a seal member 83 is arranged between the flange surface 811a and a flange surface 821a, an end portion unit 81 of a duct 65a is brought close to an end portion unit 82 of a duct 62a in a connecting direction C while each insertion portion 824 is aligned with a corresponding one of the hole portions 814. As shown in the lower diagram in FIG. 12, the end portion unit 81 and the end portion unit 82 are connected to each other in the connecting direction C with the magnetic attractive force generated between the abutment portion 825 and the abutment portion 815.

Since the insertion/removal direction between insertion portion 824 and the hole portion 814 coincides with the connecting direction C, the insertion portion 824 is inserted into the hole portion 814. Inserting the insertion portion 824 into the hole portion 814 will engage them with each other and position them with each other in a direction intersecting the connecting direction C (the radial direction of the central axis lines L1 and L2) between the end portion unit 81 and the end portion unit 82, thereby completing centering of the cylindrical portions 812 and 822.

The seal member 83 is clamped between the flange surface 811a and the flange surface 821a and pressed by these flange surfaces. This improves the airtightness of the connection portion.

With the above process, the connecting work is completed. Engaging the insertion portion 824 with the hole portion 814 can perform positioning between the ducts 62a and 65a with relatively high accuracy and can facilitate the connecting work by using a magnetic force.

Note that examples of a magnetic attractive force and the repulsive force of the seal member 83 are similar to those in the first embodiment. The configurations of the end portion units 81 and 82 may be interchanged in accordance with the duct 65a and the duct 62a. In addition, two seal members 83 may be respectively bonded to a flange surface 811a and the flange surface 821a in advance. In addition, in the present embodiment, a support member 71 is not necessary as a member on which a magnetic attractive force acts.

### Third Embodiment

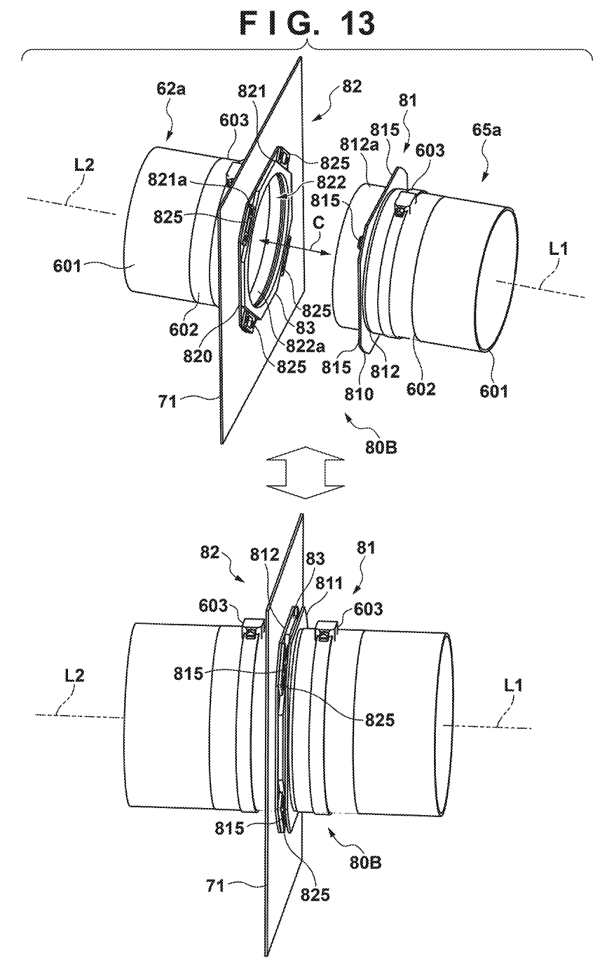

FIG. 13 shows another configuration example of the connection structure 80. Configurations different from those in the second embodiment will be described.

A flange surface 821a of an end portion member 820 is not provided with an insertion portion 824, and an abutment portion 825 is additionally provided at the position of the insertion portion 824. The plurality of abutment portions 825 are arranged at an equal pitch in the circumferential direction of a cylindrical portion 822 (the circumferential direction of a central axis line L2). In the present embodiment, four abutment portions 825 are formed.

A flange portion 811 of an end portion member 810 is not provided with a hole portion 814, and an abutment portion 815 is additionally provided at the position of the hole portion 814. The plurality of abutment portions 815 are arranged at an equal pitch in the circumferential direction of a cylindrical portion 812 (the circumferential direction of a central axis line L1). In the present embodiment, four abutment portions 815 are formed.

Part of the cylindrical portion 812 of the end portion member 810 forms an insertion portion 812a. The insertion portion 812ahas a cylindrical shape that protrudes to the opposite side (the duct 62a side) to a hose 601 with respect to the flange portion 811 and is coaxial with the central axis line L1. The cylindrical portion 822 of the end portion member 820 forms a hole portion 822a into which the insertion portion 812a is inserted.

Referring to the upper diagram in FIG. 13, in a state in which a seal member 83 is arranged between the flange surface 811a and a flange surface 821a, an end portion unit 81 of a duct 65a is brought close to an end portion unit 82 of a duct 62a in a connecting direction C while an insertion portion 812a is aligned with the hole portion 822a. As shown in the lower diagram in FIG. 13, the end portion unit 81 and the end portion unit 82 are connected to each other in the connecting direction C with the magnetic attractive force generated between the abutment portion 825 and the abutment portion 815.

Since the insertion/removal direction between insertion portion 812a and the hole portion 822a coincides with the connecting direction C, the insertion portion 812a is inserted into the hole portion 822a. Inserting the insertion portion 812a into the hole portion 822a will engage them with each other and position them with each other in a direction intersecting the connecting direction C (the radial direction of the central axis lines L1 and L2) between the end portion unit 81 and the end portion unit 82, thereby completing centering of the cylindrical portions 812 and 822.

The seal member 83 is clamped between the flange surface 811a and the flange surface 821a and pressed by these flange surfaces. This improves the airtightness of the connection portion.

With the above process, the connecting work is completed. Engaging the insertion portion 812a with the hole portion 822a can perform positioning between the ducts 62a and 65a with relatively high accuracy and can facilitate the connecting work by using a magnetic force.

Note that examples of a magnetic attractive force and the repulsive force of the seal member 83 are similar to those in the second embodiment. The configurations of the end portion units 81 and 82 may be interchanged in accordance with the duct 65a and the duct 62a. In addition, the configurations of the insertion portion 812a and the hole portion 822a may be interchanged in accordance with the end portion units 81 and 82. Two seal members 83 may be respectively bonded to the flange surface 811a and the flange surface 821a in advance. In addition, in the present embodiment, a support member 71 is not necessary as a member on which a magnetic attractive force acts.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a 'non-transitory computer-readable storage medium') to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)TM), a flash memory device, a memory card, and the like.

While the present disclosure has been described with reference to exemplary embodiments, it is to be understood that the present disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2025-073569, filed Apr. 25, 2025, which is hereby incorporated by reference herein in its entirety.

What is claimed is:

1. A printing apparatus comprising:
a conveyance unit configured to convey a print medium;
a printing unit configured to print an image on the print medium; and
first and second ducts configured to form an exhaust passage for a gas in the printing apparatus,
wherein the first duct including a first end portion unit at an end portion of the first duct,
the second duct includes a second end portion unit connected to the first end portion unit at an end portion of the second duct,
one of the first end portion unit and the second end portion unit has a magnetic force generating portion configured to attract the other of the first end portion unit and the second end portion unit in a connecting direction with a magnetic force,
one of the first end portion unit and the second end portion unit includes a hole portion,
the other of the first end portion unit and the second end portion unit includes an insertion portion inserted into the hole portion at the time of connecting,
the magnetic force generating portion is formed from a permanent magnet, and
the connecting direction is an inserting direction of the insertion portion with respect to the hole portion.

2. The apparatus according to claim 1, wherein the insertion portion is the magnetic force generating portion.

3. The apparatus according to claim 2, wherein the first end portion unit includes a first end portion member provided with the insertion portion,
the second end portion unit includes a second end portion member provided with the hole portion and a magnetic member fixed to the second end portion member, and
the hole portion is located closer to the first end portion member than the magnetic member at the time of connecting.

4. The apparatus according to claim 1, wherein the first end portion unit includes a first flange surface,
the second end portion unit includes a second flange surface facing the first flange surface at the time of connecting,
the first flange surface includes a first abutment portion,
the second flange surface includes a second abutment portion that abuts on the first abutment portion, and
the first abutment portion is the magnetic force generating portion.

5. The apparatus according to claim 1, wherein the first end portion unit and the second end portion unit respectively include cylindrical portions that communicate with each other at the time of connecting and form a fluid passage, and
the hole portion has an arcuated shape extending in a circumferential direction of the cylindrical portion.

6. The apparatus according to claim 1, wherein the first end portion unit includes a first cylindrical portion forming a fluid passage,
the second end portion unit includes a second cylindrical portion that communicates with the first cylindrical portion at the time of connecting and forms a fluid passage,
the hole portion is formed by one of the first cylindrical portion and the second cylindrical portion, and
the insertion portion is formed by the other of the first cylindrical portion and the second cylindrical portion.

7. The apparatus according to claim 1, wherein the first end portion unit includes a first flange surface,
the second end portion unit includes a second flange surface facing the first flange surface at the time of connecting, and
a seal member is clamped between the first flange surface and the second flange surface.

8. The apparatus according to claim 1, further comprising a fixing unit configured to fix the image on the print medium,
wherein the first duct and the second duct form an exhaust passage for a gas from the fixing unit.

9. The apparatus according to claim 8, wherein the printing unit includes a printhead configured to discharge ink to the print medium,
wherein the fixing unit is a drying unit configured to blow air to the print medium.

10. The apparatus according to claim 1, wherein one of the first end portion unit and the second end portion unit is fixed in the printing apparatus.

11. The apparatus according to claim 1, wherein attractive force originating from a magnetic force generated by the magnetic force generating portion is an attractive force small enough to allow a worker to manually separate the first end portion unit and the second end portion unit.

12. The apparatus according to claim 8, further comprising:
a first housing configured to accommodate the fixing unit; and
a second housing configured to accommodate an electrical circuit configured to drive the fixing unit,
wherein the first duct and the second duct extend into the second housing.

13. The apparatus according to claim 1, further comprising third and fourth ducts configured to form an exhaust passage for a gas in the printing apparatus,
wherein the third and fourth ducts are connected to each other with a connection member using no magnetic force.
